(19) United States
(12) Patent Application Publication
(10) Pub. No.: US 2022/0041188 A1
(43) Pub. Date: Feb. 10, 2022

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventors: Daiki KANEICHI, Tokyo-to (JP); Takuma FUTOHASHI, Tokyo-to (JP); Kento NITTA, Tokyo-to (JP)

(73) Assignee: TOYOTA JIDOSHA KABUSHIKI KAISHA, Toyota-shi (JP)

(21) Appl. No.: 17/384,982

(22) Filed: Jul. 26, 2021

(30) Foreign Application Priority Data
Aug. 7, 2020 (JP) 2020-134781

(51) Int. Cl. B60W 60/00; G05D 1/02; G06Q 10/08

(52) U.S. Cl. CPC B60W 60/00256; G05D 2201/0216; G06Q 10/083; G05D 1/0287

(57) ABSTRACT

An object is to manage work by a mover who works to move vehicles. A predetermined region is provided with a stopping spots of different types where the vehicles stop, and a movement order that is an order of priority related to the movement of a vehicle from one stopping spot to another stopping spot is predetermined on the basis of the type of the one stopping spot and the type of the other stopping spot. An information processing apparatus determines a vehicle order that is an order of priority related to the movement of each of target vehicles to be moved by the mover who works to move the vehicles inside the predetermined region among the vehicles, on the basis of the type of a current stopping spot and the type of a destination stopping spot for each of the target vehicles and the movement order.

### CROSS REFERENCE TO THE RELATED APPLICATION

This application claims the benefit of Japanese Patent Application No. 2020-134781, filed on Aug. 7, 2020, which is hereby incorporated by reference herein in its entirety.

### BACKGROUND

### Technical Field

The present disclosure relates to an information processing apparatus, an information processing method, and a system that manage work by a mover who works to move a plurality of vehicles inside a predetermined region.

### Description of the Related Art

Japanese Patent Laid-Open No. 2006-91951 discloses a vehicle inspection system that accepts an inspection of a vehicle. The vehicle inspection system in Japanese Patent Laid-Open No. 2006-91951 includes a vehicle related database. A schedule related data file that manages a schedule for vehicle inspection is added to the vehicle related database in the vehicle inspection system. The schedule related data file includes a monthly schedule file provided with at least a day-of-month field and an inspection type field corresponding to each day, and a daily schedule file that cooperates with the monthly schedule file and is provided with at least a time-of-day field and an inspection type field corresponding to each time. Additionally, in the vehicle inspection system, the inspection type field corresponding to a day in the monthly schedule file or a time in the daily schedule file can be accessed.

### SUMMARY

An object of the present disclosure is to manage work by a mover who works to move a plurality of vehicles.

An information processing apparatus according to a first aspect of the present disclosure is

an information processing apparatus that manages work by a mover who works to move a plurality of vehicles inside a predetermined region,

the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,

the information processing apparatus comprising a controller comprising at least one processor configured to:

determine a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order; and

transmit instruction information including the vehicle order for the plurality of target vehicles to a terminal associated with the mover.

An information processing method according to a second aspect of the present disclosure is

an information processing method executed by a computer that manages work by a mover who works to move a plurality of vehicles inside a predetermined region,

the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,

the information processing method comprising:

determining a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order; and

transmitting instruction information including the vehicle order for the plurality of target vehicles to a terminal associated with the mover.

A system according to a third aspect of the present disclosure is

a system comprising: an information processing apparatus that manages work by a mover who works to move a plurality of vehicles inside a predetermined region; and a terminal associated with the mover, wherein

the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,

the information processing apparatus determines a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order, and

the terminal receives instruction information including the vehicle order for the plurality of target vehicles from the information processing apparatus.

According to the present disclosure, it is possible to manage work by a mover who works to move a plurality of vehicles.

### BRIEF DESCRIPTION OF THE DRAWINGS

FIG. 1 is a diagram illustrating a schematic configuration of a work management system;

FIG. 2 is a diagram illustrating an example of a vehicle base;

FIG. 3 is a block diagram schematically illustrating an example of a functional configuration of a mover terminal, a management server, and a crew terminal;

FIG. 4 is a diagram illustrating an example of conditions when a controller determines whether or not each vehicle is movable;

FIG. 5 is a diagram illustrating an example of a table structure of instruction information;

FIG. 6 is a diagram illustrating an example of an instruction screen;

FIG. 7 is a diagram illustrating an example of a completion screen; and

FIG. 8 is a sequence diagram illustrating a flow of information and processing in the work management system.

### DESCRIPTION OF THE EMBODIMENTS

An information processing apparatus according to a first aspect of the present disclosure is an information processing apparatus that manages work by a mover. The mover works to move a plurality of vehicles inside a predetermined region. Inside the predetermined region, a plurality of stopping spots where the plurality of vehicles stop are provided, each of which is a different type of spot. In addition, a movement order is predetermined for the plurality of stopping spots inside the predetermined region. The movement order is an order of priority related to the movement of a vehicle from one stopping spot to another stopping spot, and is predetermined on the basis of the type of the one stopping spot and the type of the other stopping spot.

A controller in the information processing apparatus according to the first aspect of the present disclosure determines a vehicle order, that is, an order of priority related to the movement of each of a plurality of target vehicles among the plurality of vehicles, on the basis of the type of a current stopping spot and the type of a destination stopping spot for each of the plurality of target vehicles and the movement order. Here, a target vehicle is a vehicle to be moved by the mover. Additionally, the controller in the information processing apparatus transmits instruction information including the vehicle order for each of the plurality of target vehicles to a terminal associated with the mover. The mover receives the instruction information on his or her terminal, and thereby is able to grasp the vehicle order for each of the plurality of target vehicles that the mover is supposed to move.

As described above, the mover is able to work to move a plurality of vehicles on the basis of the vehicle order according to the information processing apparatus. In this way, the work by the mover can be managed by the information processing apparatus.

Hereinafter, a specific embodiment of the present disclosure will be described on the basis of the drawings. Properties such as the dimensions, materials, shapes, and relative arrangement of the components described in the present embodiment are not intended to limit the technical scope of the present disclosure thereto unless specifically indicated otherwise.

### Embodiment

(Overview of System)

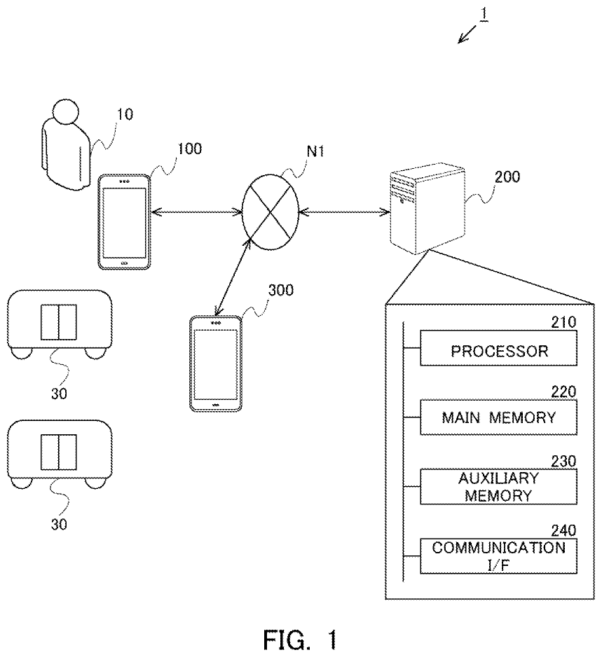

A work management system 1 according to the present embodiment will be described on the basis of FIG. 1. FIG. 1 is a diagram illustrating a schematic configuration of the work management system 1. The work management system 1 includes a mover terminal 100, a management server 200, and a crew terminal 300.

A plurality of vehicles 30 in FIG. 1 are electric vehicles having a motor as a source of motive power. In addition, the vehicles 30 are vehicles capable of autonomous travel. Each vehicle 30 provides a predetermined service by autonomously traveling outside a vehicle base. Crew members for providing the predetermined service board the vehicles 30 that travel outside the vehicle base. Also, battery charging and maintenance (inspection and servicing) are performed on each of the vehicles 30 inside the vehicle base. At this time, each vehicle 30 does not autonomously travel inside the vehicle base, but instead is moved by being driven manually by a mover 10.

The mover terminal 100 is a terminal associated with the mover 10. The crew terminal 300 is a terminal associated with the crew. Here, the mover terminal 100 and the crew terminal 300 may each be a personal computer, a smartphone, a wearable terminal, or a tablet computer, for example.

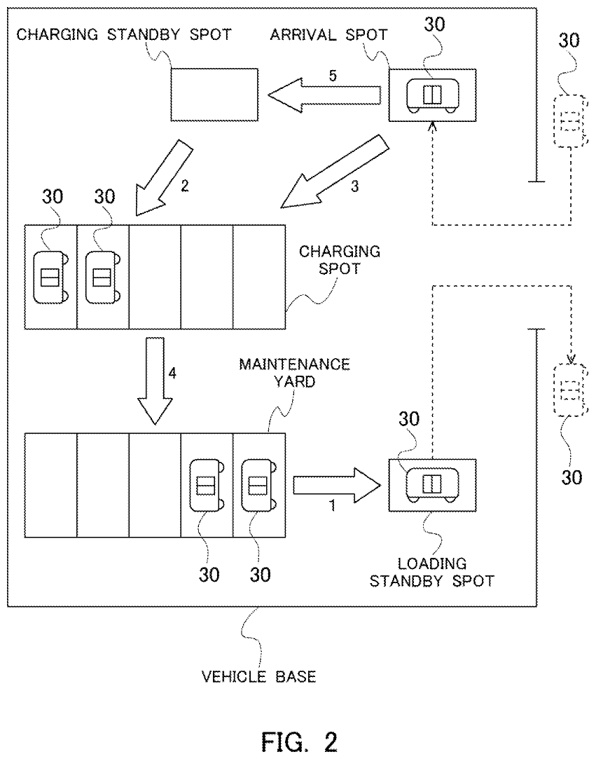

The mover 10 works to move the plurality of vehicles 30 inside the vehicle base. FIG. 2 is a diagram illustrating an example of a vehicle base. In the example illustrated in FIG. 2, the vehicle base is provided with a plurality of stopping spots where each vehicle 30 stops. The plurality of stopping spots are different types of spots, including an arrival spot, a charging spot, a charging standby spot, a maintenance yard, and a loading standby spot. Note that in the present embodiment, the types of stopping spots such as the arrival spot, the charging spot, the charging standby spot, the maintenance yard, and the loading standby spot are determined according to the purpose of stopping the vehicles 30. The purpose of stopping the vehicles 30 in each stopping spot will be described later.

The arrival spot is a stopping spot where a vehicle 30 that had been traveling outside the vehicle base stops when returning to the vehicle base. One vehicle 30 can stop at the arrival spot. Note that when a vehicle 30 arrives at the arrival spot, the crew member(s) who had been riding the vehicle 30 exit the vehicle 30.

Also, the charging spot is a stopping spot for charging the battery of each vehicle 30. Five vehicles 30 can stop at the charging spot. Also, the charging standby spot is a spot where a vehicle 30 stands by before moving to the charging spot. In the case where there is no free space in the charging spot, a vehicle 30 stands by at the charging standby spot. A single vehicle 30 can stop at the charging standby spot.

Also, the maintenance yard is a stopping spot where the vehicles 30 undergo maintenance. Five vehicles 30 can stop at the maintenance yard. Also, the loading standby spot is a stopping spot where a vehicle 30 stands by before departing from the vehicle base. Note that one or more crew members board the vehicle 30 standing by at the loading standby spot.

The mover 10 drives the vehicles 30 inside the vehicle base, and works to move the vehicles 30 from one stopping spot to another stopping spot. Specifically, the mover 10 moves a vehicle 30 from the arrival spot to the charging spot or the charging standby spot, from the charging standby spot to the charging spot, from the charging spot to the maintenance yard, or from the maintenance yard to the loading standby spot. Note that the numbers of vehicles 30 that can stop at each of the arrival spot, the charging spot, the charging standby spot, the maintenance yard, and the loading standby spot are not limited to the numbers described above. The vehicle base in the present embodiment corresponds to a “predetermined region” according to the present disclosure. The loading standby spot in the present embodiment corresponds to a “first spot” according to the present disclosure. The charging spot in the present disclosure corresponds to a “second spot” according to the present disclosure. The charging standby spot in the present disclosure corresponds to a “third spot” according to the present disclosure. The arrival spot in the present disclosure corresponds to a “fourth spot” according to the present disclosure.

The management server 200 is a server apparatus that manages the work by the mover 10. The management server 200 includes a computer provided with a processor 210, main memory 220, auxiliary memory 230, and a communication interface (communication I/F) 240. The processor 210 is a central processing unit (CPU) or a digital signal processor (DSP), for example. The main memory 220 is random access memory (RAM), for example. The auxiliary memory 230 is read-only memory (ROM), for example. Alternatively, the auxiliary memory 230 is a hard disk drive (HDD) or a disc-based recording medium such as a CD-ROM, a DVD, or a Blu-ray Disc, for example. The auxiliary memory 230 may also be a removable medium (removable storage medium). Examples of removable media include USB memory or an SD card. The communication I/F 240 is a local area network (LAN) interface board or a wireless communication circuit for wireless communication, for example.

In the management server 200, an operation system (OS), various programs, various information tables, and the like are stored in the auxiliary memory 230. Also, in the management server 200, the processor 210 is capable of achieving various functions like the functions described later by loading a program stored in the auxiliary memory 230 into the main memory 220 and executing the program. However, some or all of the functions in the management server 200 may also be achieved by a hardware circuit such as an ASIC or an FPGA. Note that the management server 200 is not necessarily realized by a single physical configuration, and may also be configured by a plurality of computers that cooperate with each other.

In the work management system 1, the mover terminal 100, the management server 200, and the crew terminal 300 are interconnected by a network N1. A wide area network (WAN), that is, a global public communication network such as the Internet, or a telephone communication network such as a mobile phone network may be adopted as the network N1, for example.

(Functional Configuration)

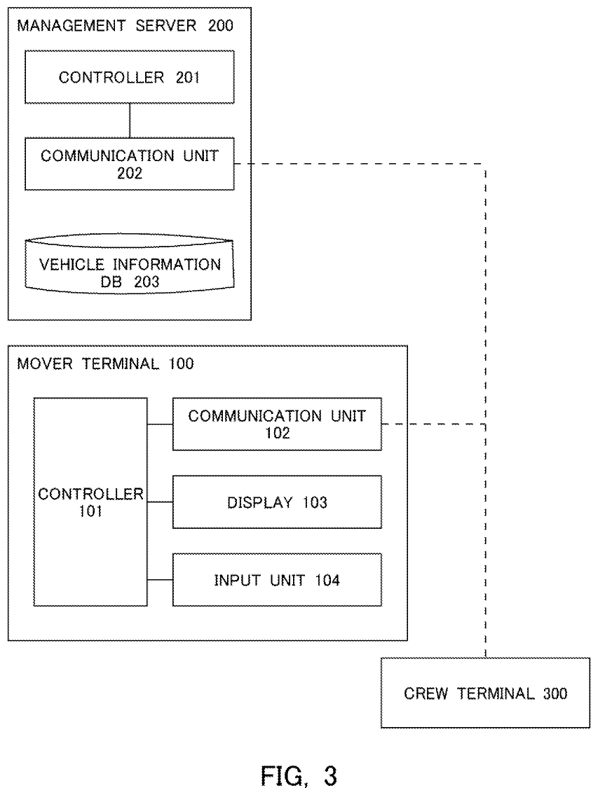

Next, a functional configuration of each of the mover terminal 100, the management server 200, and the crew terminal 300 forming the work management system 1 will be described on the basis of FIGS. 3 to 7. FIG. 3 is a block diagram schematically illustrating an example of a functional configuration of the mover terminal 100, the management server 200, and the crew terminal 300.

(Management Server)

The management server 200 includes a controller 201, a communication unit 202, and a vehicle information database (vehicle information DB) 203. The controller 201 has a function of performing computational processing for controlling the management server 200. The controller 201 can be achieved by the processor 210 in the management server 200. The communication unit 202 has a function of connecting the management server 200 to the network N1. The communication unit 202 can be achieved by the communication I/F 240 in the management server 200.

When a vehicle 30 arrives at the arrival spot, a crew member who had been riding the vehicle 30 uses the crew terminal 300 to transmit arrival information indicating that the vehicle 30 has arrived at the arrival spot to the management server 200. On the basis of the arrival information received by the communication unit 202, the controller 201 can ascertain that the vehicle 30 is stopped at the arrival spot. Also, in the case where the movement of a vehicle 30 from one stopping spot to another stopping spot as described above is completed inside the vehicle base, the mover 10 uses the mover terminal 100 to transmit completion information indicating that the movement of the vehicle 30 is complete to the management server 200. The controller 201 receives the completion information transmitted from the mover terminal 100 with the communication unit 202. By receiving the completion information, the controller 201 can ascertain the current stopping spot of the vehicle 30. On the basis of the arrival information and the completion information, the controller 201 generates vehicle information related to the current stopping spot of each vehicle 30 inside the vehicle base, and stores the generated vehicle information in the vehicle information DB 203. Also, on the basis of the vehicle information, the controller 201 can ascertain whether a free space for stopping another vehicle 30 exists in each of the arrival spot, the charging spot, the charging standby spot, the maintenance yard, and the loading standby spot.

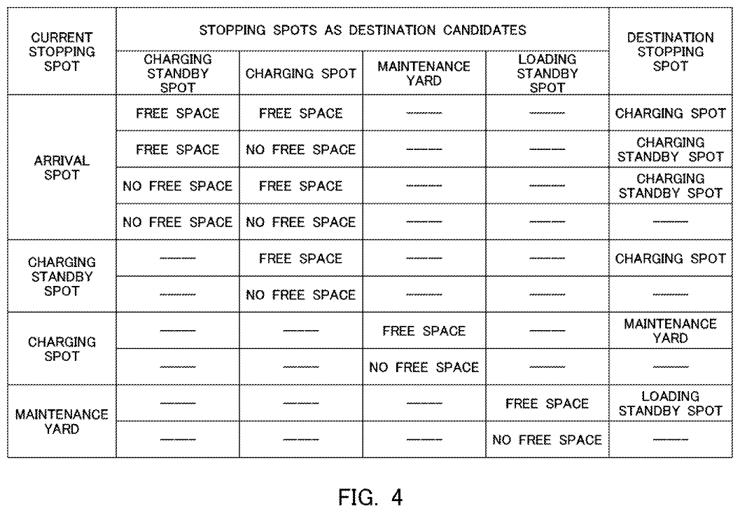

The controller 201 acquires the vehicle information stored in the vehicle information DB 203. Thereafter, the controller 201 determines which vehicles 30 are to be moved by the mover 10 (hereinafter referred to as the “target vehicles” in some cases) on the basis of the current stopping spot of each vehicle 30 and whether a free space exists in each stopping spot. At this point, the controller 201 distinguishes whether or not each vehicle 30 is movable on the basis of the current stopping spot of each vehicle 30 and whether a free space exists in each stopping spot. Thereafter, the controller 201 determines a vehicle 30 judged to be movable from among the plurality of vehicles 30 as a target vehicle 30. FIG. 4 is a diagram illustrating an example of conditions when the controller 201 distinguishes whether or not each vehicle 30 is movable.

In the example illustrated in FIG. 4, for a vehicle 30 currently stopped at the arrival spot, the controller 201 distinguishes whether or not the vehicle 30 is movable on the basis of whether a free space exists in the charging standby spot and the charging spot. Also, for a vehicle 30 currently stopped at the arrival spot, the controller 201 determines the destination stopping spot for the vehicle 30 (hereinafter simply referred to as the “destination” in some cases) as either the charging standby spot or the charging spot, on the basis of whether a free space exists in the charging standby spot and the charging spot. In the case where a free space exists in both the charging standby spot and the charging spot, the controller 201 determines that the vehicle 30 is movable. At this time, the controller 201 determines the charging spot as the destination. Also, in the case where a free space exists in the charging standby spot but not in the charging spot, the controller 201 determines that the vehicle 30 is movable. At this time, the controller 201 determines the charging standby spot as the destination. Also, in some cases there is no free space in the charging standby spot, but there is a free space in the charging spot. In such cases, on the basis of the vehicle order expressing an order of priority related to moving as described later, the mover 10 prioritizes moving the vehicle 30 stopped at the charging standby spot to the charging spot over the vehicle 30 stopped at the arrival spot. In other words, the mover 10 moves the vehicle 30 stopped at the charging standby spot to the charging spot before moving the vehicle 30 stopped at the arrival spot. With this arrangement, when the mover 10 moves the vehicle 30 stopped at the arrival spot, a free space exists in the charging standby spot. Accordingly, the controller 201 determines that the vehicle 30 is movable. At this time, the controller 201 determines the charging standby spot as the destination. Also, in the case where a free space exists in neither the charging standby spot nor the charging spot, the controller 201 determines that the vehicle 30 is not movable. In other words, in this case, the vehicle 30 stands by at the arrival spot.

Also, for a vehicle 30 currently stopped at the charging standby spot, the controller 201 distinguishes whether or not the vehicle 30 is movable on the basis of whether a free space exists in the charging spot. In the case where a free space exists in the charging spot, the controller 201 determines that the vehicle 30 is movable. At this point, the destination for the vehicle 30 is the charging spot. Also, in the case where a free space does not exist in the charging spot, the controller 201 determines that the vehicle 30 is not movable. In other words, in this case, the vehicle 30 stands by at the charging standby spot.

Also, for a vehicle 30 currently stopped at the charging spot, the controller 201 distinguishes whether or not the vehicle 30 is movable on the basis of whether a free space exists in the maintenance yard. In the case where a free space exists in the maintenance yard, the controller 201 determines that the vehicle 30 is movable. At this point, the destination for the vehicle 30 is the maintenance yard. Note that a vehicle 30 stopped at the charging spot and determined to be movable by the controller 201 is a vehicle 30 having a battery that has finished charging. Also, in the case where a free space does not exist in the maintenance yard, the controller 201 determines that the vehicle 30 is not movable. In other words, in this case, the vehicle 30 stands by at the charging spot.

Also, for a vehicle 30 currently stopped at the maintenance yard, the controller 201 distinguishes whether or not the vehicle 30 is movable on the basis of whether a free space exists in the loading standby spot. In the case where a free space exists in the loading standby spot, the controller 201 determines that the vehicle 30 is movable. At this point, the destination for the vehicle 30 is the loading standby spot. Note that a vehicle 30 stopped at the maintenance yard and determined to be movable by the controller 201 is a vehicle 30 for which maintenance is finished. Also, in the case where a free space does not exist in the loading standby spot, the controller 201 determines that the vehicle 30 is not movable. In other words, in this case, the vehicle 30 stands by at the maintenance yard.

Furthermore, a movement order is predetermined for each of the stopping spots inside the vehicle base. The movement order is an order of priority related to the movement of a vehicle 30 from one stopping spot to another stopping spot, and is predetermined on the basis of the type of the one stopping spot and the type of the other stopping spot. Here, the movement order inside the vehicle base will be described on the basis of FIG. 2. In FIG. 2, each white arrow illustrates the movement of a vehicle 30 from one stopping spot to another stopping spot. Additionally, the numeral beside each white arrow indicates the movement order. As illustrated in FIG. 2, the movement of a vehicle 30 from the maintenance yard to the loading standby spot is set highest in the movement order. Next, the movement of a vehicle 30 from the charging standby spot to the charging spot is set second-highest in the movement order. Next, the movement of a vehicle 30 from the arrival spot to the charging spot is set third-highest in the movement order. Next, the movement of a vehicle 30 from the charging spot to the maintenance yard is set fourth-highest in the movement order. Also, the movement of a vehicle 30 from the arrival spot to the charging standby spot is set fifth-highest (lowest) in the movement order.

The controller 201 determines a vehicle order, that is, an order of priority related to the movement of each of a plurality of target vehicles 30, on the basis of the type of the current stopping spot and the type of the destination for each of the plurality of target vehicles 30 and the movement order. Here, the controller 201 determines the vehicle order in the order of the movement order corresponding to the type of the current stopping spot and the type of the destination for each of the plurality of target vehicles 30.

In the case where a plurality of target vehicles 30 are stopped at the charging spot or the maintenance yard, a plurality of vehicles 30 having the same type of current stopping spot and the same type of destination exist. In this case, the controller 201 determines the vehicle order in the order of the vehicles 30 having the longest standby time in the current stopping spot. For example, in the case where two target vehicles 30 stopped at the charging spot exist, the controller 201 sets the target vehicle 30 having the longer standby time at the charging spot (a time period of not moving from the charging spot) higher in the vehicle order.

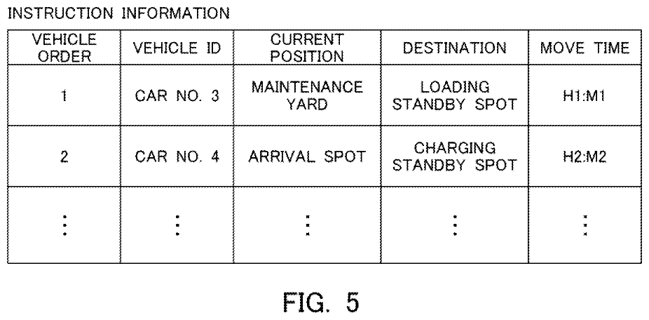

Furthermore, the controller 201 generates instruction information including the current stopping spot, the destination, and the vehicle order for the plurality of target vehicles 30. FIG. 5 is a diagram illustrating an example of a table structure of instruction information. FIG. 5 illustrates an example of a case in which one vehicle 30 is stopped at the maintenance yard, and a free space exists in the loading standby spot. FIG. 5 also illustrates an example of a case in which one vehicle 30 is stopped at the arrival spot, a free space does not exist in the charging spot, and a free space exists in the charging standby spot. Also, as illustrated in FIG. 5, the instruction information table includes a vehicle order field, a vehicle ID field, a current position field, a destination field, and a move time field.

In the vehicle order field, the vehicle order for each target vehicle 30 is input. In the vehicle ID field, an identifier for identifying each target vehicle 30 is input. In the current position field, the type of the current stopping spot for each target vehicle 30 is input. In the current position field, “arrival spot”, “charging spot”, “charging standby spot”, or “maintenance yard” is input. In the destination field, the type of the destination for each target vehicle 30 is input. In the destination field, “charging spot”, “charging standby spot”, “maintenance yard”, or “loading standby spot” is input. In the move time field, a time at which the mover 10 is supposed to move each target vehicle 30 (hereinafter referred to as the “move time” in some cases) is input. Here, the move time for each target vehicle 30 is determined on the basis of the vehicle order. The controller 201 transmits instruction information to the mover terminal 100 through the communication unit 202. Thereafter, the mover 10 works to move the plurality of target vehicles 30 on the basis of the instruction information.

Here, as described above, the movement of a vehicle 30 from the maintenance yard to the loading standby spot is set highest in the movement order. In other words, a vehicle 30 that moves to the loading standby spot is higher in the movement order than a vehicle 30 that moves to a spot other than the loading standby spot. With this arrangement, in the case where a target vehicle 30 is stopped at the maintenance yard and a free space exists in the loading standby spot, the target vehicle 30 stopped at the maintenance yard is higher in the movement order than a target vehicle 30 stopped at another stopping spot. Consequently, the mover 10 is instructed to give the highest priority to moving a target vehicle 30 that has completed maintenance at the maintenance yard to the loading standby spot. Consequently, the mover 10 can prioritize moving the target vehicle 30 stopped at the maintenance yard to the loading standby spot, and put the target vehicle 30 in a standby state ready to travel outside the vehicle base. As a result, when it is necessary to cause a vehicle 30 to travel outside the vehicle base, it is possible to avoid a situation in which a vehicle 30 that is ready to travel is not standing by at the loading standby spot, and the vehicle 30 cannot depart from the vehicle base.

Also, the movement of a vehicle 30 from the charging standby spot to the charging spot is set second-highest in the movement order. Also, the movement of a vehicle 30 from the arrival spot to the charging spot is set third-highest in the movement order. In this way, by setting the movement order, the mover 10 prioritizes moving a target vehicle 30 to the charging spot next after the target vehicle 30 that is moved to the loading standby spot. With this arrangement, the time until the charging of a vehicle 30 (target vehicle 30) is started can be shortened. Consequently, by starting the charging of a vehicle 30 early, the charging of the vehicle 30 can be completed at an earlier time. For this reason, it is possible to avoid a situation in which the charging spot is full of vehicles 30 that have not finished charged. Also, the movement of a vehicle 30 from the charging standby spot to the charging spot is higher in the movement order than the movement of a vehicle 30 from the arrival spot to the charging spot. With this arrangement, in the case where target vehicles 30 are stopped at both the arrival spot and the charging standby spot, a free space does not exist in the charging standby spot, and a free space exists in the charging spot, the target vehicle 30 that the mover 10 moves from the charging standby spot to the charging spot is higher in the movement order than the target vehicle 30 that the mover 10 moves from the arrival spot to the charging spot. Consequently, in this case, the mover 10 can move the target vehicle 30 stopped at the charging standby spot to the charging spot first.

(Mover Terminal)

The mover terminal 100 includes a controller 101, a communication unit 102, a display 103, and an input unit 104. The controller 101 has a function of performing computational processing for controlling the mover terminal 100. The controller 101 can be achieved by a processor in the mover terminal 100. Also, the communication unit 102 has a function of connecting the mover terminal 100 to the network N1. The communication unit 102 can be achieved by a communication I/F in the mover terminal 100. The display 103 has a function of displaying various information to the mover 10. The display 103 can be achieved by a touch panel in the mover terminal 100. The input unit 104 has a function of inputting various information into the mover terminal 100. The input unit 104 can be achieved by a touch panel in the mover terminal 100.

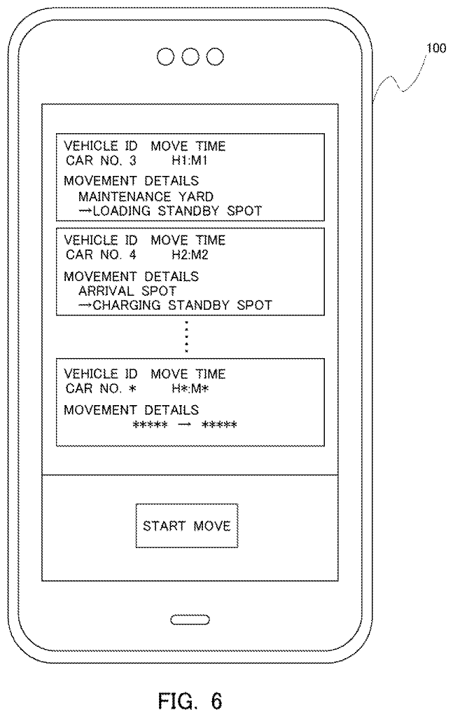

The controller 101 receives instruction information from the management server 200 through the communication unit 102. At this time, the controller 101 causes an instruction screen related to the instruction information to be displayed on the display 103. FIG. 6 is a diagram illustrating an example of the instruction screen. As illustrated in FIG. 6, a plurality of move instructions are displayed on the instruction screen on the basis of the instruction information, with each move instruction containing a vehicle ID, a move time, and movement details. Also, in the movement details, the current stopping spot and the destination for a target vehicle 30 are displayed. Also, a Start Move button pressed when the mover 10 starts moving a target vehicle 30 is displayed on the instruction screen. Also, the move instructions for the target vehicles 30 are displayed on the instruction screen in order of highest vehicle order from the top. The mover 10 uses the input unit 104 to select the move instruction for the target vehicle 30 he or she is going to move, and presses the Start Move button when starting to move the target vehicle 30. At this time, the mover 10 does not necessarily have to select the move instruction for the target vehicle 30 displayed on top (the move instruction for the target vehicle 30 in first place of the vehicle order). With this arrangement, for example, when it is necessary to move a target vehicle 30 in an irregular order different from the vehicle order, the mover 10 can move a target vehicle 30 other than the target vehicle 30 in first place of the vehicle order first. In other words, the mover 10 is able to move the target vehicles 30 flexibly.

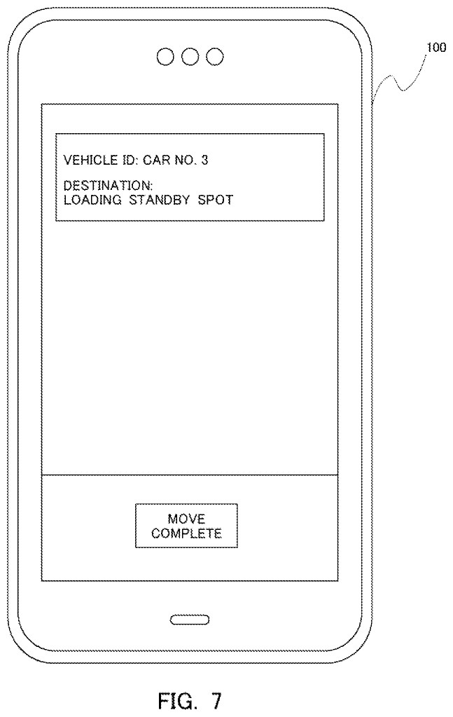

When the Start Move button is pressed on the instruction screen, a completion screen that the mover 10 operates after completing the movement of a vehicle 30 is displayed on the display 103. FIG. 7 is a diagram illustrating an example of the completion screen. Note that the example illustrated in FIG. 7 is the completion screen displayed in the case where the mover 10 selects the move instruction for the target vehicle 30 designated Car No. 3 and presses the Start Move button in the example illustrated in FIG. 6. On the completion screen, the vehicle ID and the type of the destination are displayed for target vehicle 30 that the mover 10 selected on the instruction screen illustrated in FIG. 6. Additionally, when the mover 10 has finished moving the target vehicle 30 that he or she selected, the mover 10 presses a Move Complete button on the completion screen. When the mover 10 presses the Move Complete button, the controller 201 transmits completion information to the management server 200.

(Crew Terminal)

The crew terminal 300 includes a controller, a communication unit, a display, and an input unit, similarly to the mover terminal 100. The crew terminal 300 transmits arrival information to the management server 200 through the communication unit.

(Information/Process Flow)

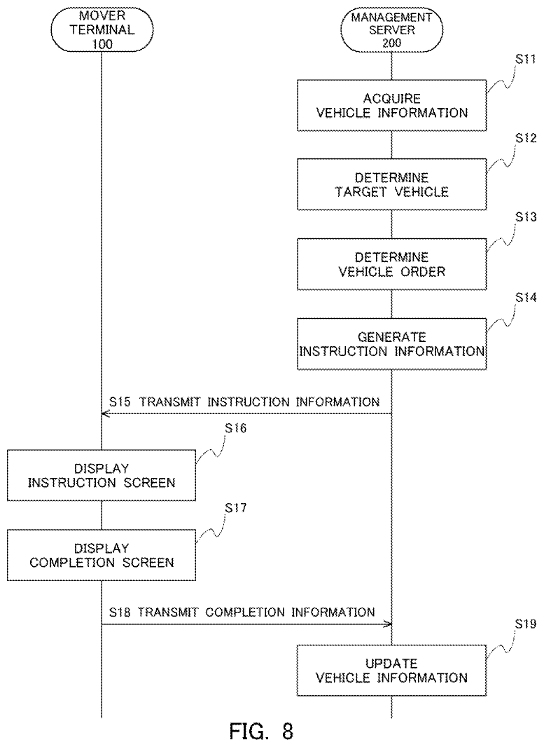

Next, the flow of information and each process between the mover terminal 100 and the management server 200 in the work management system 1 will be described on the basis of FIG. 8. FIG. 8 is a sequence diagram illustrating a flow of information and processing in the work management system 1. Note that transmission and reception of information as well as each process illustrated in FIG. 8 are executed repeatedly.

In the work management system 1, the management server 200 acquires vehicle information from the vehicle information DB 203 (S11). Then, the management server 200 determines a target vehicle 30 on the basis of the current stopping spot of each vehicle 30, and whether a free space for a vehicle 30 to stop at exists in each stopping spot (S12). Additionally, at this time, in the case where a vehicle 30 whose current stopping spot is the arrival spot exists, the management server 200 determines the destination of the vehicle 30 on the basis of whether a free space exists in the charging spot and the charging standby spot. Next, the management server 200 determines the vehicle order for each target vehicle 30 on the basis of the type of the current stopping spot and the type of the destination for each target vehicle 30 and the movement order (S13). Next, the management server 200 generates instruction information (S14). Then, the management server 200 transmits the instruction information to the mover terminal 100 (S15). Here, in the case where a plurality of movers 10 are present, instruction information is transmitted to the mover terminal 100 of each mover 10.

The mover terminal 100 receives the instruction information and displays the instruction screen (S16). On the instruction screen, the mover 10 selects the move instruction for the target vehicle 30 he or she is going to move, and presses the Start Move button. When the Start Move button is pressed, the completion screen is displayed on the mover terminal 100 (S17). When the mover 10 has finished moving the target vehicle 30, the mover 10 presses the Move Complete button on the completion screen. When the Move Complete button is pressed, the mover terminal 100 transmits completion information to the management server 200 (S18).

By receiving the completion information, the management server 200 can ascertain that the mover 10 has finished moving the target vehicle 30. In other words, from the completion information, the management server 200 can ascertain the current stopping spot of each vehicle 30, including the target vehicle 30, after the mover 10 has moved the target vehicle 30. Accordingly, the management server 200 receiving the completion information updates the vehicle information stored in the vehicle information DB 203 on the basis of the completion information (S19).

While the processes from S11 to S19 are being executed, the management server 200 may receive arrival information from the crew terminal 300 in some cases. In such cases, the management server 200 updates the vehicle information to indicate that a vehicle 30 is stopped at the arrival spot in the process of S19 performed after receiving the arrival information.

As described above, in the work management system 1, the mover 10 is able to move a plurality of target vehicles 30 on the basis of the vehicle order included in the instruction information. In this way, the work by the mover 10 can be managed by the work management system 1.

(Modifications)

In the present embodiment, a plurality of stopping spots are provided, and the type of each stopping spot is determined according to the purpose of stopping the vehicles 30. However, the purpose of stopping the vehicles 30 at each of the stopping spots may also be the same. For example, in some cases, the mover 10 moves the vehicles 30 inside a mechanical multi-story parking garage provided with a plurality of levels. In this case, the type may be determined according to the level on which a vehicle 30 is stopped in the mechanical multi-story parking garage. In this case, the mover 10 works to move the level where a vehicle 30 is currently stopped to a different level on the basis of the vehicle order included in the instruction information. With this arrangement, the mover 10 is able to move a vehicle 30 to a level efficient for parking the vehicle 30.

In addition, the management server 200 does not necessarily have to receive completion information from the mover terminal 100. Also, the management server 200 does not necessarily have to receive arrival information from the crew terminal 300. For example, a sensor installed in each stopping spot may detect whether or not a vehicle 30 is stopped at each stopping spot, and each sensor may transmit completion information or arrival information to the management server 200.

### Other Embodiments

The embodiment described above is merely one example, and the present disclosure may be carried out by making appropriate modifications within a scope that does not depart from the gist of the present disclosure. Additionally, the processes and means described in the present disclosure may be combined freely, insofar as a technical contradiction is not produced.

Also, a process described as being performed by a single apparatus may also be executed in a distributed manner by a plurality of apparatuses. Alternatively, a process described as being performed by different apparatuses may be executed by a single apparatus. In a computer system, the kind of hardware configuration (server configuration) with which each function is achieved can be modified flexibly.

The present disclosure is also achievable by supplying a computer program implementing the functions described in the foregoing embodiment to a computer, and causing one or more processors included in the computer to load and execute the program. Such a computer program may be provided to the computer through a non-transitory computer readable medium that is connectible to a system bus of the computer, or may be provided to the computer over a network. The non-transitory computer readable medium includes any type of medium suited to storing electronic instructions, including any type of disk such as a magnetic disk (such as a floppy(R) disk or a hard disk drive (HDD)) or an optical disc (such as a CD-ROM, a DVD, or a Blu-ray Disc), read-only memory (ROM), random access memory (RAM), EPROM, EEPROM, a magnetic card, flash memory, or an optical card, for example.

What is claimed is:

1. An information processing apparatus that manages work by a mover who works to move a plurality of vehicles inside a predetermined region,
the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,
the information processing apparatus comprising a controller comprising at least one processor configured to:
determine a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order; and
transmit instruction information including the vehicle order for the plurality of target vehicles to a terminal associated with the mover.

2. The information processing apparatus according to claim 1, wherein in a plurality of target vehicles having the same type of the current stopping spot and the same type of the destination stopping spot among the plurality of target vehicles, the controller raises a target vehicle having a longer standby time at the current stopping spot higher in the vehicle order.

3. The information processing apparatus according to claim 1, wherein the type of each stopping spot is determined according to a purpose of stopping the vehicles.

4. The information processing apparatus according to claim 3, wherein the plurality of stopping spots include a first spot where a vehicle stands by before traveling outside the predetermined region, and the movement of a vehicle from a stopping spot other than the first spot to the first spot is higher in the movement order than the movement of a vehicle between stopping spots other than the first spot.

5. The information processing apparatus according to claim 3, wherein
the plurality of stopping spots include a second spot where a vehicle stops for a specific purpose, a third spot where a vehicle stands by in a case where no free space exists in the second spot, and a fourth spot where a vehicle stops before moving to the second spot or the third spot, and
the movement of a vehicle from the third spot to the second spot is higher in the movement order than the movement of a vehicle from the fourth spot to the second spot.

6. The information processing apparatus according to claim 5, wherein
the plurality of vehicles are electric vehicles,
the second spot is a charging spot for charging the vehicles, and
the third spot is a charging standby spot where the vehicles stand by in a case where no free space exists in the charging spot.

7. The information processing apparatus according to claim 1, wherein the controller is further configured to determine the plurality of target vehicles on a basis of the current stopping spot for each of the plurality of vehicles and whether a free space exists in each of the plurality of stopping spots.

8. The information processing apparatus according to claim 7, wherein the controller is further configured to determine the destination stopping spot for each of the plurality of target vehicles on a basis of the current stopping spot for each of the plurality of vehicles and whether a free space exists in each of the plurality of stopping spots.

9. The information processing apparatus according to claim 1, wherein the controller is further configured to update vehicle information related to the current stopping spot for each of the plurality of vehicles in a case of receiving completion information indicating that the mover has finished moving a target vehicle.

10. An information processing method executed by a computer that manages work by a mover who works to move a plurality of vehicles inside a predetermined region,
the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,
the information processing method comprising:
determining a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order; and
transmitting instruction information including the vehicle order for the plurality of target vehicles to a terminal associated with the mover.

11. The information processing method according to claim 10, wherein in a plurality of target vehicles having the same type of the current stopping spot and the same type of the destination stopping spot among the plurality of target vehicles, a target vehicle having a longer standby time at the current stopping spot is raised higher in the vehicle order.

12. The information processing method according to claim 10, wherein the type of each stopping spot is determined according to a purpose of stopping the vehicles.

13. The information processing method according to claim 12, wherein the plurality of stopping spots include a first spot where a vehicle stands by before traveling outside the predetermined region, and the movement of a vehicle from a stopping spot other than the first spot to the first spot is higher in the movement order than the movement of a vehicle between stopping spots other than the first spot.

14. The information processing method according to claim 12, wherein
the plurality of stopping spots include a second spot where a vehicle stops for a specific purpose, a third spot where a vehicle stands by in a case where no free space exists in the second spot, and a fourth spot where a vehicle stops before moving to the second spot or the third spot, and
the movement of a vehicle from the third spot to the second spot is higher in the movement order than the movement of a vehicle from the fourth spot to the second spot.

15. The information processing method according to claim 14, wherein
the plurality of vehicles are electric vehicles,
the second spot is a charging spot for charging the vehicles, and
the third spot is a charging standby spot where the vehicles stand by in a case where no free space exists in the charging spot.

16. The information processing method according to claim 10, further comprising: determining the plurality of target vehicles on a basis of the current stopping spot for each of the plurality of vehicles and whether a free space exists in each of the plurality of stopping spots.

17. The information processing method according to claim 16, further comprising: determining the destination stopping spot for each of the plurality of target vehicles on a basis of the current stopping spot for each of the plurality of vehicles and whether a free space exists in each of the plurality of stopping spots.

18. The information processing method according to claim 10, further comprising: updating vehicle information related to the current stopping spot for each of the plurality of vehicles in a case of receiving completion information indicating that the mover has finished moving a target vehicle.

19. A system comprising: an information processing apparatus that manages work by a mover who works to move a plurality of vehicles inside a predetermined region; and a terminal associated with the mover, wherein
the predetermined region being provided with a plurality of stopping spots of different types where the plurality of vehicles stop, and a movement order that is an order of priority related to the movement of a vehicle from one stopping spot to another stopping spot being predetermined for the plurality of stopping spots on a basis of the type of the one stopping spot and the type of the other stopping spot,
the information processing apparatus determines a vehicle order that is an order of priority related to the movement of each of a plurality of target vehicles to be moved by the mover among the plurality of vehicles, on a basis of the type of a current stopping spot and the type of a destination stopping spot for each of the plurality of target vehicles and the movement order, and
the terminal receives instruction information including the vehicle order for the plurality of target vehicles from the information processing apparatus.

20. The system according to claim 19, wherein in a plurality of target vehicles having the same type of the current stopping spot and the same type of the destination stopping spot among the plurality of target vehicles, the information processing apparatus raises a target vehicle having a longer standby time at the current stopping spot higher in the vehicle order.
